(19) United States
(12) Patent Application Publication
(10) Pub. No.: US 2017/0264136 A1
(43) Pub. Date: Sep. 14, 2017

(54) Multiple Energy Accumulator System for Motor Vehicle Electrical Systems

(71) Applicant: Bayerische Motoren Werke Aktiengesellschaft, Muenchen (DE)

(72) Inventors: Moritz Schindler, Muenchen (DE); Axel Reinfelder, Muenchen (DE); Markus Mauerer, Muenchen (DE)

(21) Appl. No.: 15/601,589

(22) Filed: May 22, 2017

Related U.S. Application Data
(63) Continuation of application No. PCT/EP2015/077342, filed on Nov. 23, 2015.

(30) Foreign Application Priority Data
Nov. 25, 2014 (DE) 10 2014 223 971.0

(51) Int. Cl. H02J 7/14; H02K 7/18; H02P 9/00; B60R 16/03

(52) U.S. Cl. CPC H02J 7/1423; B60R 16/0307; H02K 7/1815; H02P 9/008

(57) ABSTRACT

The invention relates to a vehicle electrical system that includes a first energy accumulator which has a first maximum open circuit voltage when the first energy accumulator is fully charged, and a second energy accumulator which has a second maximum open-circuit voltage when the second energy accumulator is fully charged. The second maximum open circuit voltage is higher than the first maximum open circuit voltage. The vehicle electrical system also includes a generator configured to generate electrical energy for the vehicle electrical system and a control unit that is configured to detect a recuperation mode of the vehicle. The control unit is also configured to cause the generator, while the vehicle is in the recuperation mode, to generate electrical energy with a charge voltage which is in or above a buffer voltage range, wherein the buffer voltage range lies between the first maximum open circuit voltage and the second maximum open circuit voltage.

### CROSS REFERENCE TO RELATED APPLICATIONS

This application is a continuation of PCT International Application No. PCT/EP2015/077342, filed Nov. 23, 2015, which claims priority under 35 U.S.C. §119 from German Patent Application No. 10 2014 223 971.0, filed Nov. 25, 2014, the entire disclosures of which are herein expressly incorporated by reference.

### BACKGROUND AND SUMMARY OF THE INVENTION

The invention relates to a method and to a corresponding device for making available a multiplicity of electrical energy accumulators in a vehicle electrical system of a vehicle.

A vehicle (in particular a road vehicle such as e.g. a passenger car, a truck or a motorcycle) typically comprises a vehicle electrical system which is configured to supply one or more electrical consumers of the vehicle with electrical energy from an electrical energy accumulator (e.g. from a low voltage battery).

The use of a multiplicity of energy accumulators in the vehicle electrical system of a vehicle can be advantageous, for example in order to prolong the service life of the individual energy accumulators, in order to permit increased power output and/or in order to recuperate kinetic energy of the vehicle as electrical energy to an increased degree and to store said energy in the vehicle electrical system. In particular, one or more further energy accumulators (e.g. one or more lithium accumulators) can be used in a low-voltage vehicle electrical system (e.g. in the case of a vehicle electrical system voltage of approximately 12V) in addition to a lead accumulator, in order to store electrical energy recuperated from a generator of the vehicle (e.g. from a dynamo).

The present disclosure relates to the technical problem of making available an advantageous combination of energy accumulators for a vehicle electrical system of a vehicle. Furthermore, the present disclosure relates to the technical problem of operating a combination of energy accumulators of a vehicle electrical system of a vehicle in an advantageous way.

According to one aspect, a vehicle electrical system for a vehicle (in particular for a road vehicle, e.g. for a passenger car, a truck or a motorcycle) is described. The vehicle electrical system comprises a first energy accumulator and a second energy accumulator. The first energy accumulator and the second energy accumulator can be arranged in parallel with one another in the vehicle electrical system, if appropriate via a coupling element which can entirely or partially attenuate a connection between the first energy accumulator and the second energy accumulator.

The first energy accumulator has a first maximum open-circuit voltage when the first energy accumulator is fully charged, and the second energy accumulator has a second maximum open-circuit voltage when the second energy accumulator is fully charged. In this context, the second maximum open-circuit voltage is higher than the first maximum open-circuit voltage. The area between the first maximum open-circuit voltage and the second maximum open-circuit voltage can be used to charge electrical energy (if appropriate cyclically) into the second energy accumulator and/or extract electrical energy from the second energy accumulator, without at the same time loading the first energy accumulator with charge currents or discharge currents. In this way, the service life of the first energy accumulator can be increased.

The second maximum open-circuit voltage can be lower than or equal to a maximum permissible voltage of the first energy accumulator. In this way it is possible to ensure that the first energy accumulator is not damaged by a vehicle electrical system voltage up to the second maximum open-circuit voltage. Under certain circumstances, the second energy accumulator can also have a second maximum open-circuit voltage which exceeds the maximum permissible voltage of the first energy accumulator. There is then a capacity range of the second energy accumulator which remains unused. This can be advantageous with respect to the service life of the second energy accumulator.

Furthermore, a second minimum open-circuit voltage of the second energy accumulator can be lower than the first maximum open-circuit voltage of the first energy accumulator. It is therefore possible, when necessary, for both energy accumulators to be used simultaneously to absorb energy and/or make available energy for the vehicle electrical system.

The first energy accumulator can be configured to make available electrical stationary-mode energy and/or starting energy for the vehicle. On the other hand, the second energy accumulator can be configured to store and make available electrical energy in a cyclical fashion. The second energy accumulator preferably has (in comparison with the first energy accumulator) a higher cycle stability. For example, the second energy accumulator can be configured to have a capacity loss of not more than 20% and a power loss of maximum 50% at 3000 or more full cycles (corresponding to a discharged charge transfer of at least 3000 times the rated capacity).

A clear assignment of tasks to the first energy accumulator and to the second energy accumulator makes it possible to be able to use optimized battery technologies for the respective tasks without excess damage/shortening of the service life of the first or second energy accumulator during the operation of the vehicle electrical system. In particular, damage can be minimized and service life can be maximized. Furthermore, cost-optimized technologies can be used for the respective task. Overall, it is therefore possible to make available a reliable and cost-effective vehicle electrical system.

Owing to a clear assignment of tasks to the first energy accumulator and to the second energy accumulator it is possible to carry out corresponding dimensioning for the energy accumulators. In particular, owing to the task distribution the second energy accumulator can have a rated capacity which corresponds to a third or less of a rated capacity of the first energy accumulator. A storage technology for cyclical memories is typically more cost-intensive than a storage technology for stationary-mode energy. A cost-effective vehicle electrical system is therefore made possible by the abovementioned relative dimensioning of the first and second energy accumulators.

As a result of the assignment of tasks to the first energy accumulator and to the second energy accumulator, it is possible to use a second energy accumulator which has one or more of the following properties. In particular, a second energy accumulator can be used which has a rated capacity of at maximum 25 Ah. It has become apparent that the abovementioned capacity is sufficient for the cyclical absorption/outputting of electrical energy (in particular for recuperated electrical energy). It is therefore possible to make available a more cost-effective second energy accumulator.

In the case of recuperation, electrical energy can be made available with a charge voltage in a buffer voltage range, or above a buffer voltage range, wherein the buffer voltage range is above the first maximum open-circuit voltage. The second energy accumulator can have a charging range of 3 Ah or more in this buffer voltage range. It is therefore to possible to ensure that recuperated electrical energy can be absorbed as completely as possible. It is therefore possible to reduce the energy consumption of the vehicle.

In order to carry out the task with respect to the cyclical absorption/outputting of electrical energy, the second energy accumulator can have a ratio of discharge power to gross energy content of at least 30, in particular in the case of an operating temperature of 25° C. and in the case of a state of charge of 50%. It is therefore possible to ensure that relatively large quantities of electrical energy can be absorbed or made available even within a short time.

The second energy accumulator can have an internal resistance of 6.5 mohms or less, in particular in the case of a state of charge of approximately 50% and in the case of an operating temperature of approximately 25° C. By means of such internal resistances it is possible to ensure that even relatively high recuperation currents can be used completely to charge the second energy accumulator.

The second energy accumulator can have, in the case of operating temperatures of 0° C. or less, a charge absorption capacity which is higher than the charge absorption capacity of the first energy accumulator. Typically the charge absorption capacity of energy accumulators drops as the temperature drops. This leads to a situation in which, in particular, in the case of relatively low operating temperatures and in the case of relatively short operating phases of the vehicle, a partial discharge of the first energy accumulator can take place, which partial discharge can no longer be completely recharged in the driving mode. As a result of the increased charge absorption capacity, the second energy accumulator can absorb a relatively large quantity of electrical energy even in the case of short operating phases. This electrical energy can be output then (e.g. in an open-circuit phase of the vehicle) at least partially from the second energy accumulator to the first energy accumulator on the basis of the parallel connection. The first energy accumulator can therefore reliably carry out its tasks with respect to making available stationary-mode energy and/or starting energy even in the case of short operating phases and in the case of low operating temperatures.

The first energy accumulator can comprise one or more battery cells which are based on lead acid technology. Therefore, capacity for tasks which are assigned to the first energy accumulator can be made available efficiently. Furthermore, by using lead acid technology a first energy accumulator can be made available which has a first maximum open-circuit voltage which is equal to or less than approximately 13V. Such an energy accumulator can therefore be used in a 12V/14V low-voltage vehicle electrical system of a vehicle.

The second energy accumulator can comprise one or more of the following components or configurations. For example, a plurality of the following components can be arranged in parallel with one another. By means of the components mentioned below it is possible to make available a second energy accumulator which has a second maximum open-circuit voltage which is higher than the first maximum open-circuit voltage. Furthermore, a second energy accumulator can be made available which has a second minimum open-circuit voltage which is lower than the first maximum open-circuit voltage. It is therefore possible to make available a second energy accumulator which can absorb or output electrical energy cyclically (e.g. in the recuperation mode of the vehicle), without at the same time loading the first energy accumulator. If appropriate, the second maximum open-circuit voltage of the second energy accumulator can also assume values above the typical maximum system voltage of 15.5-16V. This voltage range can then remain unused. However, for the service life of the second energy accumulator it may be advantageous if the latter is not operated up to its maximum open-circuit voltage (i.e. up to the full charge).

The second energy accumulator can, in particular, comprise ten cells which are connected in series and which are based on nickel metal hydride technology. Alternatively or additionally, the second energy accumulator can comprise a series connection of four cells which are based on lithium-ion technology, with a metal oxide cathode, in particular a nickel manganese cobalt (NMC) cathode and/or a lithium manganese oxide (LMO) cathode, and with an anode which is based on carbon. Alternatively or additionally, the second energy accumulator can comprise a series circuit of four cells which are based on lithium-ion technology, with a lithium iron phosphate (LFP) cathode and with an anode which is based on carbon. Alternatively or additionally, the second energy accumulator can comprise a series circuit of six cells which are based on lithium-ion technology, with a metal oxide cathode, in particular a nickel manganese cobalt (NMC) cathode and/or a lithium manganese oxide (LMO) cathode, and with an anode which is based on lithium titanate (LTO). Alternatively or additionally, the second energy accumulator can comprise a series circuit of eight cells which are based on lithium-ion technology, with a lithium iron phosphate (LFP) cathode and an anode which is based on lithium titanate (LTO).

The vehicle electrical system can also comprise a generator which is configured to generate electrical energy for the vehicle electrical system. The generator can be driven here, in particular, in two parts by wheels of the vehicle and the connected drive train, in particular if the vehicle is in the recuperation mode in which the kinetic energy of the vehicle is converted into electrical energy by the generator. The generator can be configured to generate electrical energy with different voltages. In particular, electrical energy can be generated with a charge voltage which is in a buffer voltage range or above a buffer voltage range, wherein the buffer voltage range preferably lies between the first maximum open-circuit voltage (in particular above the first maximum open-circuit voltage) and the second maximum open-circuit voltage. For example, the buffer voltage range can comprise, under certain circumstances exclusively, open-circuit voltages between 13V (in particular higher than 13V) and 16V. It is therefore possible to ensure that recuperated electrical energy is absorbed exclusively by the second energy accumulator (when the first energy accumulator is fully charged). The vehicle electrical system voltage is also as a result typically higher than the first maximum open-circuit voltage (e.g. higher than 13V) subsequent to a recuperation mode. In this way, recuperated electrical energy can be extracted from the second energy accumulator without substantial loading of the first energy accumulator. In particular it is possible to ensure that electrical energy is extracted only from the second energy accumulator for as long as the vehicle electrical system voltage lies in or above the buffer voltage range.

The vehicle electrical system can comprise a control unit which is configured to detect a recuperation mode of the vehicle. For example it is possible to detect that a brake pedal of the vehicle is activated and/or that an accelerator pedal angle is less than or equal to a specific angle threshold value and the internal combustion engine is therefore in the drag mode. The control unit can also be configured to cause the generator to generate electrical energy, under certain circumstances exclusively, in the buffer voltage range or above the buffer voltage range, while the vehicle is in the recuperation mode. As already stated, it is possible in this way to ensure that recuperated electrical energy is primarily absorbed from the second energy accumulator, and is output to the vehicle electrical system again by the second energy accumulator subsequent to the recuperation. The first energy accumulator is therefore hardly loaded by the cyclical recuperation mode.

The vehicle electrical system can comprise an isolating element which is configured to prevent a flow of current between the second energy accumulator and the vehicle electrical system. The isolating element can comprise an electrical switch and/or a mechanical switch. The isolating element can be arranged on the ground side and/or positive side with respect to the second energy accumulator. The control unit can be configured to determine the presence of one or more isolating conditions. Furthermore, the control unit can be configured to cause, when one or more isolating conditions are met, the isolating element to prevent the flow of current between the second energy accumulator and the vehicle electrical system.

The one or more isolating conditions can comprise one or more of the following conditions. In a first isolating condition, the first energy accumulator has a state of charge which is equal to or higher than a predefined first charge threshold value (e.g. full charge). Furthermore, the second energy accumulator can have a state of charge which is equal to or higher than a predefined second charge threshold value. In particular, the second energy accumulator can have an open-circuit voltage which is higher than the first maximum open-circuit voltage (e.g. by at least one predefined voltage value). Furthermore, in the first isolating condition the vehicle is in a resting phase. In such a situation, the isolating element can avoid a situation in which an overload of the first energy accumulator occurs as a result of electrical energy from the second energy accumulator. The first energy accumulator can therefore be protected and energy losses can be avoided.

In a second isolating condition there is an indication that electrical energy is to be reserved for an emergency start of the vehicle. Furthermore, the vehicle can be in the open-circuit state. It is possible to detect e.g. that the state of charge of the second energy accumulator has dropped below a predefined threshold value. In such a case, the isolating element can reserve electrical energy from the second energy accumulator for an emergency start. For this purpose, the isolating element can connect the second energy accumulator to the vehicle electrical system again for an activation of a starter of the vehicle. It is therefore possible to ensure starting of the vehicle even after relatively long stationary-mode times and/or a higher stationary discharge.

In a third isolating condition, there is an indication that an open-circuit voltage measurement is to be carried out at the first energy accumulator and/or at the second energy accumulator. The first energy accumulator can be disconnected from the second energy accumulator by means of the isolating element. A reliable open-circuit voltage measurement can therefore be carried out for the respective energy accumulator.

The vehicle electrical system can comprise a bypassable additional resistor (also referred to a coupling element) which divides the vehicle electrical system into a first part with the first energy accumulator and into a second part with the second energy accumulator. The bypassable additional resistor can comprise e.g. a resistor which can be bypassed by an electrical or mechanical switch. For this purpose, the switch can be arranged parallel to the resistor. A starter of the vehicle can be arranged in the first part of the vehicle electrical system. Otherwise, one or more consumers which have an undesired behavior when the vehicle electrical system dips can be arranged in the second part of the vehicle electrical system. Fluctuations in the vehicle electrical system voltage in the second part of the vehicle electrical system can be attenuated by the bypassable additional resistor (in particular during starting of an engine). Furthermore, in contrast to complete disconnection of parts of the vehicle electrical system it is possible to ensure that the electrical energy of the first and second energy accumulators are always available in the entire vehicle electrical system. Furthermore, it is possible to ensure that electrical energy can be transmitted from the generator to the second part of the vehicle electrical system via the resistor even in an emergency mode. For this purpose, the generator can generate electrical energy with an increased voltage in order to overcome the resistance.

The control unit can be configured to cause, when a starter is activated, bypassing of the bypassable additional resistor to be cancelled in a coasting mode of the vehicle, as a result of which negative effects on consumers in the second part of the vehicle electrical system are alleviated. On the other hand, a reliable supply of (in particular safety-critical) consumers can also be ensured.

The generator can be arranged in a first region of the vehicle (typically in the direct vicinity of an internal combustion engine of the vehicle). The first region comprises here either a front region or a rear region of the vehicle. The second energy accumulator can then also be arranged in the first region of the vehicle. It is therefore possible to reduce a line resistance between the generator and the second energy accumulator, and as a result increase the efficiency in the recuperation mode. Furthermore, in this way requirements made of the internal resistance of the second energy accumulator can be reduced, therefore decreasing the cost of the second energy accumulator.

The first energy accumulator can be arranged in the first region of the vehicle (i.e. in the vicinity of the generator and of the starter of the vehicle). It is therefore possible for an efficient start of an internal combustion engine to be ensured with electrical energy from the first energy accumulator. On the other hand, the first energy accumulator can be arranged in a second region of the vehicle which corresponds to a region of the vehicle which is opposite the first region (e.g. in the rear region instead of in the front region or in the front region instead of in the rear region). Such distribution of energy accumulators in the vehicle permits a uniform voltage supply to be made available for the consumers distributed in the vehicle. Furthermore, a distributed arrangement in terms of packaging and/or distribution of weight and/or safety aspects can be advantageous.

According to a further aspect, a vehicle electrical system for a vehicle is described, wherein the vehicle electrical system comprises a first energy accumulator and a second energy accumulator. The first energy accumulator comprises here battery cells which are based on lead acid technology. The second energy accumulator comprises one or more of the abovementioned components. Therefore, in a recuperation mode of the vehicle it is possible to recuperate electrical energy in a buffer voltage range and to absorb electrical energy in the second energy accumulator and output it again without (substantially) adversely affecting the first energy accumulator in the process.

According to a further aspect, a vehicle electrical system is described for a vehicle, wherein the vehicle electrical system comprises a first energy accumulator and a second energy accumulator. The first and/or second energy accumulator has/have here one or more of the properties described in this document. It is therefore possible to make available a cost-effective and reliable vehicle electrical system for a vehicle.

According to a further aspect, a vehicle electrical system for a vehicle is described, wherein the vehicle electrical system comprises a first energy accumulator and a second energy accumulator. Furthermore, the vehicle electrical system comprises a generator which is configured to generate electrical energy for the vehicle electrical system. The generator can be arranged in a first region of the vehicle (typically in the direct vicinity of an internal combustion engine of the vehicle). The first region comprises here either a front region or a rear region of the vehicle. The second energy accumulator can then also be arranged in the first region of the vehicle. It is therefore possible to reduce a line resistance between the generator and the second energy accumulator and as a result increase efficiency in the recuperation mode. In particular, requirements can then be made of the internal resistance of the second energy accumulator and therefore the costs of the second energy accumulator can be reduced.

According to a further aspect, a vehicle (e.g. a passenger car, a truck or a motorcycle) is described. The vehicle can comprise the vehicle electrical system described in this document.

According to a further aspect, a control unit is described which comprises one or more of the features described in this document. In particular the control unit can be configured to control a generator, an isolating element and/or a coupling element of a vehicle electrical system. The control unit can be distributed among a multiplicity of control device. For example, an isolating element can be controlled by a control device of an energy accumulator. The generator and/or the coupling element can be controlled by a control device for the power management of the vehicle electrical system.

According to a further aspect, a method is described which can be executed e.g. by a control unit described in this document, and comprises features which correspond to the features of the control unit described in this document.

It is to be noted that the methods, devices and systems described in this document can be used both alone and in combination with other methods, devices and systems described in this document. Furthermore, any aspects of the methods, devices and systems described in this document can be combined with one another in a variety of ways. In particular, the features of the claims can be combined with one another in a variety of ways.

In the text which follows, the invention will be described in more detail on the basis of exemplary embodiments, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary voltage ranges of energy accumulators of a vehicle electrical system;

FIG. 2 shows exemplary energy flows in a vehicle electrical system of a vehicle;

FIG. 3 shows a block diagram of an exemplary vehicle electrical system;

FIG. 4 shows a block diagram of an exemplary vehicle electrical system with a coupling element;

FIG. 5 shows a block diagram of an exemplary vehicle electrical system with a multiplicity of partial vehicle electrical systems; and

FIGS. 6a, 6b and 6c show exemplary arrangements of energy accumulators in a vehicle.

### DETAILED DESCRIPTION OF THE DRAWINGS

As stated at the beginning, the present document is concerned with making available a vehicle electrical system with a multiplicity of energy accumulators. The multiplicity of energy accumulators is to be used, in particular, to recuperate kinetic energy of the vehicle as far as possible as electrical energy and make it available to the vehicle electrical system.

Furthermore, stationary mode energy and starting energy is to be made available in a reliable fashion. Moreover it is to be ensured that the different energy accumulators of the vehicle electrical system are not damaged substantially owing to the different requirements made of the vehicle electrical system (cyclical absorption and outputting of recuperated energy, making available stationary mode energy, making available starting energy, making available assistance energy etc.), and in this way a reduction in the service life of the energy accumulators is brought about.

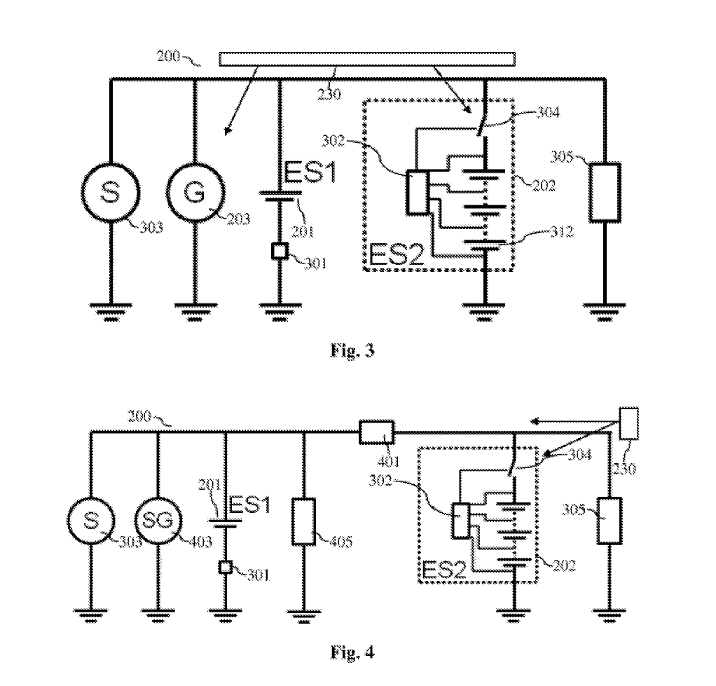

FIG. 3 shows an exemplary vehicle electrical system 200 with a multiplicity of energy accumulators 201, 202. In particular, the vehicle electrical system 200 comprises a first energy accumulator ES1 201 and a second energy accumulator ES2 202. Furthermore, the vehicle electrical system 200 comprises a generator 203 which is configured to generate electrical energy. The generator 203 can be driven here by an internal combustion engine of the vehicle (not illustrated) and/or by other parts of the power transmission system and/or by wheels of the vehicle. Furthermore, the vehicle electrical system 200 comprises a starter 303 which is configured to start the internal combustion engine of the vehicle. The generator 203 and the starter 303 can be embodied as a combined starter generator (as illustrated in FIG. 4 by means of the reference symbol 403). Furthermore, the vehicle electrical system 305 comprises one or more electrical consumers 305 (e.g. headlights, lighting system, air conditioning/heating elements etc.) of the vehicle which are operated with electrical energy from the generator 203 and/or from the energy accumulators 201, 202.

The first energy accumulator 201 and the second energy accumulator 202 are arranged in parallel with one another. The first energy accumulator 201 is based e.g. on lead acid technology. The first energy accumulator 201 can be embodied with a liquid electrolyte or with an electrolyte which is solidified by means of a glass fiber nonwoven (AGM battery) or by means of jellification (lead gel battery). The first energy accumulator 201 which is implemented by means of a lead acid battery has six series-connected units in its design for 12V/14V vehicle electrical systems, which units can each be composed of a plurality of parallel connected electrode pairs and/or cells.

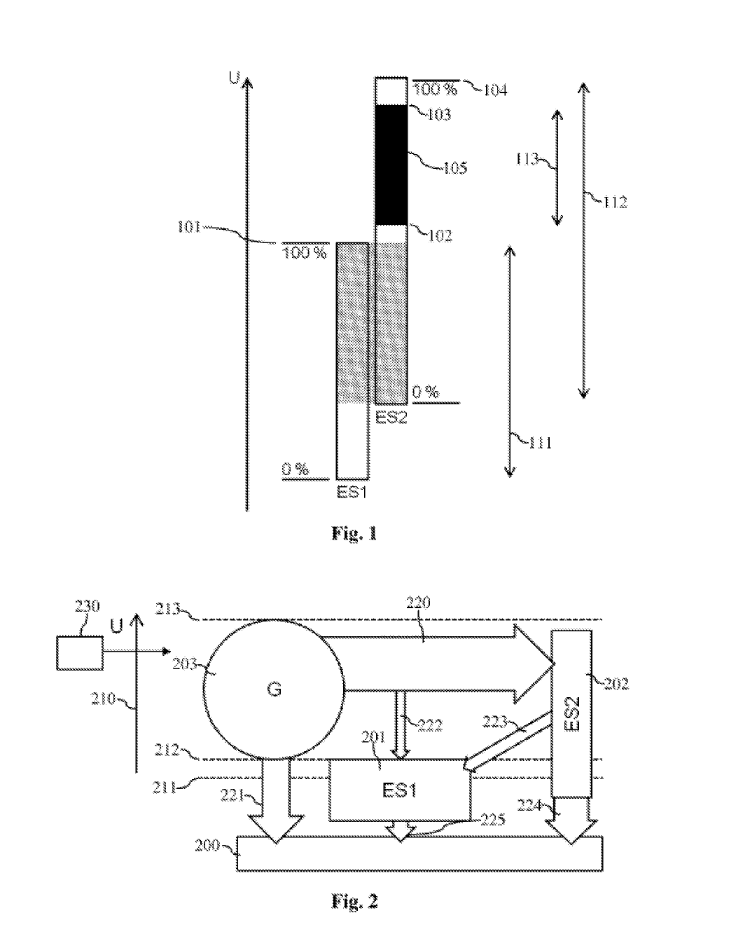

The second energy accumulator 202 can be constructed using various energy storage technologies. In this context, in one preferred example the voltage level of the second energy accumulator 202 exceeds the voltage level of the first energy accumulator 201. In particular, an open-circuit voltage of the second energy accumulator 202 can exceed the open circuit voltage of the first energy accumulator 201. This is illustrated by way of example in FIG. 1. In particular, FIG. 1 shows the first maximum open circuit voltage 101 of the first energy accumulator ES1 201 in the case of full charging (100%). The second energy accumulator ES2 202 has a second maximum open circuit voltage 104 in the case of full charging (100%), which exceeds the first maximum open circuit voltage 101. This is to say the second energy accumulator 202 can assume, through the absorption of electrical energy, a higher open circuit voltage than the first energy accumulator 201. Therefore, by defining the voltage in the vehicle electrical system 200 it is possible to control whether electrical energy is absorbed or output by the first energy accumulator 201, or not. In particular, by defining the voltage in the vehicle electrical system 200 it is possible largely to prevent cyclical absorption/outputting of electrical energy by the first energy accumulator 201. It is therefore possible to avoid substantial shortening of the service life of a first energy accumulator 201 which is based on lead acid technology, even in the case of cyclical recuperation of braking energy and of the feeding back of energy to the vehicle electrical system 200.

The second energy accumulator 202 can have one or more of the following configurations or components. For example, a plurality of the following configurations can be connected in parallel with one another, in order to make available the second energy accumulator 202. By means of the configurations it is possible to ensure, in particular, that a second maximum open-circuit voltage 104 is present which exceeds the maximum open circuit voltage 101 of the first energy accumulator 201. In this context, accumulator cells (referred to in short as cells) with different accumulator technologies can be used. The term cell refers here below to a unit which has a rated voltage which is characteristic of the respective accumulator technology. Such a cell can physically be comprised of a plurality of parallel connected elements. Exemplary configurations which the second energy accumulator 202 can comprise (in particular for a low-voltage 12V, vehicle electrical system 200 are: ten cells which are connected in series and use nickel metal hydride technology and;
a series circuit of four cells using lithium-ion technology with a metal oxide cathode, in particular nickel manganese cobalt (NMC) and/or lithium manganese oxide (LMO), and with an anode which is based on carbon;
a series circuit of four cells using lithium-ion technology with a lithium iron phosphate (LFP) cathode and with an anode which is based on carbon;
a series circuit of six cells using lithium-ion technology with a metal oxide cathode, in particular nickel manganese cobalt (NMC) and/or lithium manganese oxide (LMO), and with an anode which is based on lithium titanite (LTO); and/or
a series circuit of eight cells using lithium-ion technology with a lithium iron phosphate (LFP) cathode and an anode which is based on lithium titanite (LTO).

The cathode and the anode of a cell can each contain further additives, in particular for improving the electrode properties, such as for example conductive additives. The respective portion of such additives lies preferably below 10% here. For a vehicle electrical system with a relatively high voltage, for example 24 V or 48 V, the number of cells connected in series can be adjusted correspondingly.

By means of the abovementioned configurations it is possible to ensure that the first energy accumulator 201 has a first maximum open circuit voltage 101 which is lower than the second maximum open-circuit voltage 104 of the second energy accumulator 202. In the case of recuperation, the vehicle electrical system 200 can then be operated in or above a voltage range 105 which lies between the first maximum open circuit voltage 101 and the second maximum open circuit voltage 104. The voltage range 105 can be referred to as a buffer voltage range 105. The buffer voltage range 105 has a lower limiting voltage 102 which is typically higher than or equal to the first maximum open circuit voltage 101. Furthermore, the buffer voltage range 105 has an upper limiting voltage 103 which is typically lower than the second maximum open-circuit voltage 104. The buffer voltage range 105 can be used to recuperate electrical energy and store it in the second energy accumulator 202 and subsequently to output this electrical energy again to the vehicle electrical system 200 in order to operate the one or more electrical consumers 305. The first energy accumulator 201 is largely excepted here from the cyclical absorption and outputting of electrical energy 201 due to the charge of the buffer voltage range 105, with the result that the service life of the first energy accumulator 201 is not substantially reduced by the recuperation mode.

In particular, the generator 203 of the vehicle electrical system 200 can be made to generate, in the recuperation mode, electrical energy with a charge voltage which is in or above the buffer voltage range 105. With increasing duration of the recuperation mode, the state of charge and therefore the open-circuit voltage of the second energy accumulator ES2 typically increases here and can, under certain circumstances, even exceed the buffer voltage range 105 in the intensive recuperation mode.

The first energy accumulator 201 can primarily serve as an energy reserve (e.g. for the stationary mode operation or for the starter). On the other hand, the second energy accumulator 202 can be focused on the cyclical absorption/outputting of recuperated electrical energy. For this purpose, the first energy accumulator 201 preferably has a rated capacity which is at least three times as high as the rated capacity of the second energy accumulator 202. In other words, given a clear separation of the functions of the energy accumulators 201, 202 in the vehicle electrical system 200 (energy reserve versus recuperation and cyclical loading/power buffering) a relatively small second energy accumulator 202 can be used which has a rated capacity which is just a third or less of the rated capacity of the first energy accumulator 201. The rated capacity indicates here the charge which the energy accumulator outputs starting from its fully charged state during discharging with a constant test current (according to the test method which is customary for the respective energy storage technology) at 25° C. until the lower, technology specific switch off voltage is reached.

FIG. 1 shows as an example the first rated capacity 111 of the first energy accumulator 201 and the second rated capacity 112 of the second energy accumulator 202. In a preferred example, the second energy accumulator 202 has a second rated capacity 112 of at maximum 25 Ah.

As stated above, the second energy accumulator 202 can be focused on the cyclical absorption and outputting of electrical energy (e.g. by operation within the buffer voltage range 105). In this context, the second energy accumulator 202 can be designed to absorb or output the highest possible power levels. In one preferred example, the second energy accumulator 202 has a P/E ratio (discharge power to gross energy content) of at least 30 (e.g. of 40) in the case of a ten second discharging at 25° C. and in the case of a 50% state of charge. For example, the second energy accumulator 202 can have, in the case of approximately 25° C. and approximately 50% state of charge, a discharge power of approximately 3 kW at the lower discharge voltage as well as a gross energy content of approximately 100 Wh in the case of capacity testing with a current which is customary for the technology used, e.g. with a simple rated current in the case of Li ion technology.

Furthermore, a technology which has a relatively high cycle stability (in particular a higher cycle stability than the first energy accumulator 201) is preferably used for the second energy accumulator 202. For example, the second energy accumulator 202 can be configured for 3000 or more full cycles (corresponding to a discharging charge transfer of at least 3000 times the rated capacity) given a capacity loss of at maximum 20% and in the case of a power loss of at maximum 50%.

Compared to lead acid technology which is used for the first energy accumulator 201, all the above mentioned configurations for the second energy accumulator 202 have a substantially better charge absorption capacity (at moderate temperatures of higher than 10° C.). This improved charge absorption capacity can be used to reduce the fuel consumption of the motor vehicle within the scope of a recuperation function.

FIG. 2 illustrates an exemplary operation of the vehicle electrical system 200. The second energy accumulator 202 can be operated partially or exclusively above the fully charged state of the first energy accumulator 201. In particular, the second energy accumulator 202 can be operated partially or exclusively in the buffer voltage range 105. As a result, the recuperation function can also be presented without or with only a small contribution of the first energy accumulator 201. It is therefore possible to dispense with a significant partial discharging operation of the first energy accumulator 201 or at least to restrict said operation. This has a positive effect on the service life of a first energy accumulator 201 which is based on lead acid technology. As a result of the raised voltage level of the second energy accumulator 202, the absorbed recuperation energy is output into the vehicle electrical system after the end of a recuperation phase, and therefore a reduction in the fuel consumption is brought about on the basis of the reduced drive power demand of the generator 203. As a result of the voltage level, the first energy accumulator 201 is loaded significantly less in terms of the charge transfer than the second energy accumulator 202.

In the case of recuperation, the vehicle electrical system voltage 210 can be raised by a control unit 230 of the vehicle electrical system (e.g. by a control device of the generator 203) in order to generate electrical energy in the range of the voltages 212 to 213. The generator 203 can generate, in particular, electrical energy with a specific charge voltage 213. The charge voltage 213 can lie in or above the buffer voltage range 105 from FIG. 1. The electrical energy which is recuperated by the generator 203 is stored as energy 220 or output as energy 221 directly to consumers 305 of the vehicle electrical system 200. The energy 220 is stored primarily in the second energy accumulator 202. However, depending on the voltage level 212, 213 a (typically small) portion 222 of the energy 220 can be stored in the first energy accumulator 201. Energy 225, 224 can then be made available for the vehicle electrical system 200 from the energy accumulators 201, 202.

The second energy accumulator 202 is preferably implemented using technology (for example lithium ion technology with a lithium titanate anode) which also has better charge absorption capacity compared to the first energy accumulator 201 even at relatively low temperatures (e.g. at 0° C. or less). Therefore, a high state of charge of a first energy accumulator 201 which is implemented using lead acid technology can be ensured even at low external temperatures (e.g. at 0° C. or less). In particular, by means of a relatively high charge absorption capacity of the second energy accumulator 202 it is possible to ensure that electrical energy 220 generated by the generator 203 can be absorbed by the second energy accumulator 202 even during short charging phases. This energy which is stored in the second energy accumulator 202 can then be transmitted to the first energy accumulator 201 (energy 223 in FIG. 2) subsequently (e.g. when a vehicle is shut down) by the passive coupling of the parallel circuit without using active energy conversion elements.

In other words, the lead acid technology typically gives rise to a relatively poor charge absorption capacity of the first energy accumulator 201 at relatively low temperatures. Therefore, in an operating situation with short charging cycles (e.g. driving over short distances) energy 225 which has been extracted from the first energy accumulator 201 can only be recharged insufficiently, with the result that the state of charge of the first energy accumulator 201 drops owing to the short charging phases. As a result of substantial charging of the second energy accumulator 202 (owing to the relatively increased charge absorption capacity), the second energy accumulator 202 can act on the first energy accumulator 201 as a charging device and recharge the first energy accumulator 201, even when a vehicle is shutdown. It is therefore possible for a relatively high state of charge of the first energy accumulator 201 to be ensured, and therefore for the service life of the first energy accumulator 201 to be prolonged.

The charge transfer of the first energy accumulator 201 is significantly reduced through the operation of the vehicle electrical system 200 in a voltage range 105 which is predominantly above the fully charged state of the first energy accumulator 201. This has positive consequences for the service life of the first energy accumulator 201.

A control device 301 which is specified as an intelligent battery sensor (IBS), which monitors the state of the first energy accumulator 201 on the basis of voltage, current and optional temperature (see FIG. 3), can be assigned to the first energy accumulator 201. The first storage control device 301 can, for example, detect information about the state of charge and the power capacity of the first energy accumulator 201 and make it available to a superordinate control device 230 of the vehicle.

The second energy accumulator 202 can have a control device 302 which is integrated in the memory and is specified as a battery management system (BMS). The second accumulator control device 302 can monitor the state of the second energy accumulator 202 on the basis of voltage, current and, if appropriate temperature. Furthermore, the second storage control device 302 can, for example, detect information about the state of charge and the power capacity of the second energy accumulator 202 and make it available to a superordinate control device 230. Furthermore, by virtue of the voltage measurement of subgroups of a cell package of the second energy accumulator 202 it is possible to set the symmeterization status of the cells 312, i.e. the equal distribution of the state of charge and/or power state and, if appropriate, be compensated by active symmeterization (by means of DC/DC converters) or passive symmeterization (by means of the parallel connection of resistors to form the subgroups of a cell packet which have an excessively increased state of charge.

In particular, when the second energy accumulator 202 is embodied in lithium-ion technology, the second energy accumulator 202 can comprise an electrical isolating element 304 in the form of a mechanical or electronic relay. This isolating element 304 can be actuated by the second storage control device 302 and/or by the control unit 230. By means of this isolating element 304, the second energy accumulator 202 can be disconnected from the vehicle electrical system 200 in states which are critical owing to safety aspects or ageing aspects, and further consequences can therefore be avoided.

Alternatively or additionally, this isolating element 304 can be used within the scope of the operating strategy of the vehicle electrical system 200 in order
to maintain an energy reserve for an engine start when there is a risk of discharging of the first energy accumulator 201 or of an overall energy storage system,
to permit the first storage control device 301 at the first energy accumulator 201 and/or the second storage control device 302 of the second energy accumulator 202 the possibility of measuring the open-circuit voltage in order to determine precisely the detected state of charge of the respective energy accumulator 201, 202, and
to avoid damage to the first energy accumulator 201 (e.g. in the operating situation described below.

An exemplary operating situation in which it may be appropriate to open the isolating element 304 when the first energy accumulator 201 is fully charged and a relatively high state of charge of the second energy accumulator 202 is present. Since the first energy accumulator 201 is already fully charged, no transfer of charge from the second energy accumulator 202 to the first energy accumulator 201 can take place. However, in the case of a first energy accumulator 201 which is based on lead acid technology the gassing stream increases disproportionately as the voltage rises and can therefore bring about damage to the first energy accumulator 201. It may therefore be appropriate, after the shutting down of the vehicle, to disconnect the second energy accumulator 202 from the vehicle electrical system 200 by means of the isolating element or switching element 304, in order to avoid damage to the first energy accumulator 201.

As illustrated in FIG. 3, in the vehicle electrical system 200 the positive poles of the two energy accumulators ES1 201 and ES2 202 are connected via a corresponding line, and the negative poles are each connected to the bodywork as ground or directly to one another via a corresponding line. The consumers 305 can be permanently connected consumers or consumers which can be disconnected by means of switching elements. The consumers 305 are illustrated in the figures as a single consumer only for the sake of simplification of the graphic illustration.

In the example illustrated in FIG. 3, the battery sensor 301 is provided in the ground line of the first energy accumulator 201. The second energy accumulator 202 comprises not only the storage cells 312 but also the battery management system 302 and a switch, i.e. an isolating element, 304. The switch 304 can be of electronic or mechanical design and, if appropriate, integrated outside the housing of the second energy accumulator 302 and/or in the ground path. The generator 203 can also be embodied as what is referred to as a starter-generator (as illustrated in FIG. 4). In this case, if appropriate the starter 303 can be dispensed with.

FIG. 4 shows a vehicle electrical system 200 in which the overall vehicle electrical system 200 can be divided into two parts by a coupling element 401. In particular, a degree of exchange of energy between the first energy accumulator 201 and the second energy accumulator 202 can be influenced by the coupling element 401. The coupling element 401 is arranged between the first energy accumulator 201 and the second energy accumulator 202. The vehicle electrical system consumers 305, 405 can be connected in one of the two, if appropriate also in parallel in the two, vehicle electrical system branches or partial vehicle electrical systems. Which consumer 305, 405 is connected in which vehicle electrical system branch can depend on the voltage stability requirements of the respective consumer 305, 405. Consumers 305 which require a voltage with a relatively high stability can be arranged in the vehicle electrical system branch of the second energy accumulator 202, while consumers 405 which have relatively reduced requirements of the stability of the supply voltage can be arranged in the vehicle electrical system branch of the first energy accumulator 201.

The coupling element 401 can be implemented by means of a bypassable diode and/or by means of a bypassable additional resistor. In particular, the coupling element 401 can comprise an attenuating element (e.g. a resistor) which causes fluctuations in the vehicle electrical system voltage in the first vehicle electrical system branch, i.e. in the vehicle electrical system branch of the first energy accumulator 201, to be attenuated with the result that relatively reduced fluctuations of the vehicle electrical system voltage occur in the second vehicle electrical system branch, i.e. in the vehicle electrical system branch of the second energy accumulator 202. The coupling element 401 can for this purpose be configured in such a way that although the coupling element 401 has an attenuating effect, the potentials in the first and second vehicle electrical system branches are not disconnected.

By using a coupling element 401 the intensity of the flow of energy can be influenced in one direction (when a diode is used) or by means of a resistor. If an electronic or mechanical switch is used in the coupling element 401, the vehicle electrical system branches can be completely disconnected from one another. The selection of the switching element of the coupling element 401 is determined here typically according to the characteristic of the starting system 303 with respect to a current demand and according to the characteristic of the vehicle electrical system consumers 305, 405 with respect to the requirements in terms of voltage stability and also according to the properties of the energy accumulators 201, 202. In particular when an engine stop function is implemented in the so-called coasting mode, the supply of all the safety-relevant consumers 305, 405 has to be ensured in the provided voltage range here. This can be fulfilled by means of a corresponding configuration and actuation of the coupling element 401.

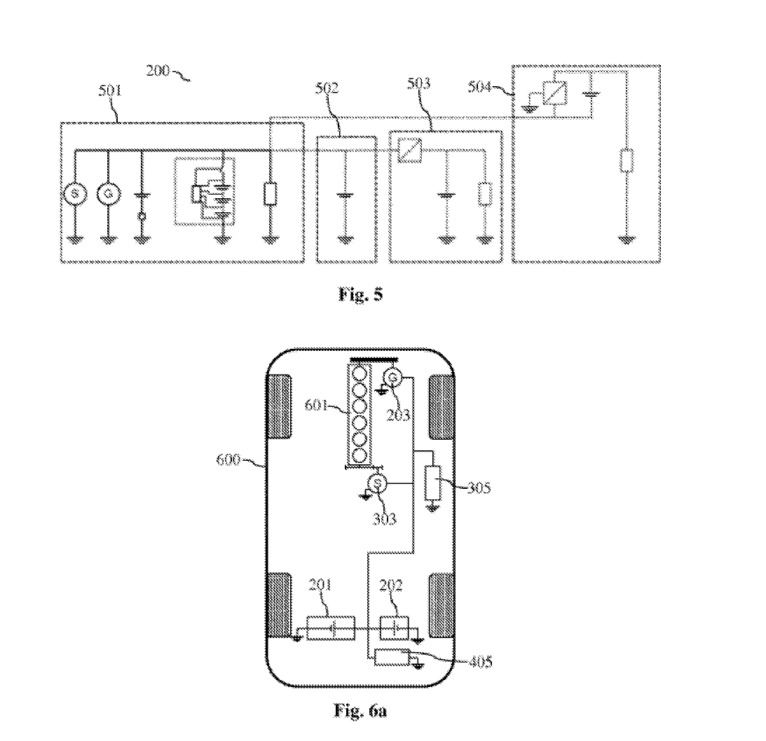

FIG. 5 shows further expansions of the vehicle electrical system 200 by means of energy accumulators 502 which are connected in parallel or in series and by means of vehicle electrical system expansions 503, 504 which are coupled by means of a switching element and/or by means of a DC/DC converter. Such expansions can be used in conjunction with the aspects described in this document. In this context, the coupling element 401 illustrated in FIG. 4 can also be used in the basic vehicle electrical system 501.

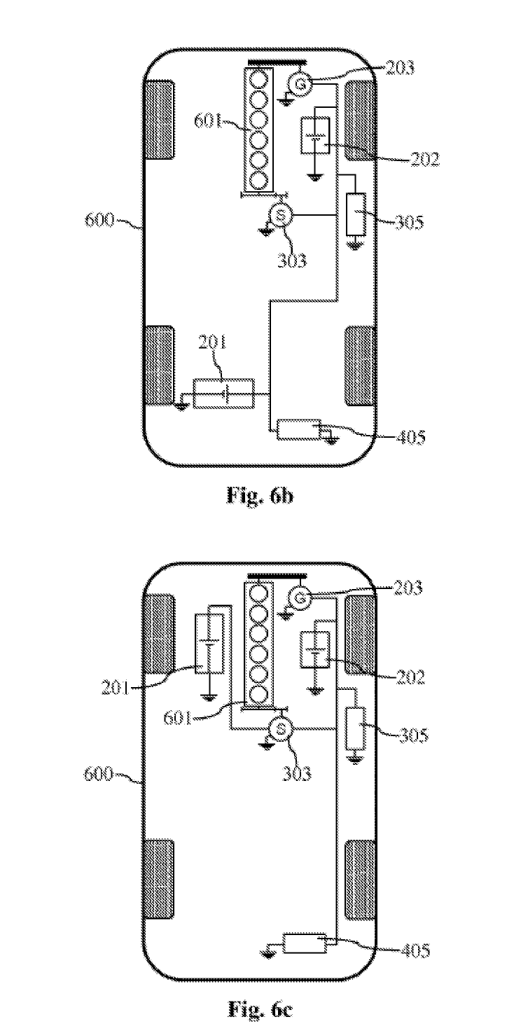

FIGS. 6a, 6b and 6c show exemplary arrangements of the energy accumulators 201, 202 in a vehicle 600. In order to permit advantageous distribution of weight in the vehicle 600, the first energy accumulator 201 is arranged in a vehicle 600 with rear-wheel drive, typically in the rear region of the vehicle 600. The second energy accumulator 202 can, as illustrated in FIG. 6a, be arranged in the rear region, directly by the first energy accumulator 202. This has the advantage of lower scopes of change owing to the use of a second energy accumulator 202. On the other hand, this results in a relatively large line length from the generator 203 to the second energy accumulator 202 (if the generator 203 and the internal combustion engine 601 are located in the front region of the vehicle 600).

Against the background of the recuperation function in the scope of which the highest possible currents are to be transmitted with the best possible efficiency, the length of the connecting line between the generator 203 and the second energy accumulator 202 is of particular significance. Relatively large losses in the line system increase the requirements made in respect of a low internal charging resistance of the second energy accumulator 202 and therefore give rise to higher costs. Furthermore, the arrangement illustrated in FIG. 6a gives rise to long lines to the high-power consumers which are located in the front region, such as, for example, the steering system, brake system and stability system.

In the arrangement illustrated in FIG. 6b, the second energy accumulator 202 is located in the direct vicinity of the generator 203. This typically results in a reduction in the feed line resistance by 1.5-2 mohms and a reduction in the total line resistance of up to 50% (compared to the arrangement illustrated in FIG. 6a). Furthermore, in terms of the stability of the vehicle electrical system there is the advantage that the consumers 305 in the front region of the vehicle 600 (i.e. in the vicinity of the second energy accumulator 202) can benefit directly from the stabilizing effect of the second energy accumulator 202.

FIG. 6c illustrates a further arrangement which is comparable to the arrangement in FIG. 6b in terms of the recuperation potential and the resulting requirements made of the second energy accumulator 202. The location of the first energy accumulator 201 in the front region of the vehicle 600 (and therefore in relative proximity to the internal combustion engine 601 and to the starter 303) also results in advantages with respect to the available starting power for the starter 303. Furthermore, there are cost advantages owing to the relatively short line lengths. On the other hand, a limited voltage stability may occur for consumers 405 in the rear region of the vehicle 600. Furthermore, in the case of recuperation there is typically a higher voltage at the first energy accumulator 201, which can have a disadvantageous effect on the service life of the first energy accumulator 201, and which can or has to be compensated by means of a corresponding configuration of the lines and connections.

As explained in conjunction with FIGS. 1 and 2, in the case of recuperation the vehicle electrical system voltage 210 can be raised to charge voltages 213 in or above the buffer voltage range 105. The buffer voltage range 105 is preferably above the first maximum open-circuit voltage 101 here. Furthermore, it should be ensured that the charge voltage 213 and therefore also the voltages in the buffer voltage range 105 are not higher than a first maximum voltage above which the first energy accumulator 201 is damaged. In the case of lead acid batteries having a defined electrolyte, the first maximum voltage is typically 14.8-15.2 V. In the case of lead acid batteries with a liquid electrolyte, the first maximum voltage is 16.0 V. The generator 203 can be configured to make available an output voltage, i.e. a charge voltage 213, in the range of at maximum up to 15.5-16.0 V. If appropriate, relatively high charge voltages 213 can also be used in order to compensate high line losses in the case of unfavorable dimensioning thereof.

In the text which follows, exemplary dimensioning of a vehicle electrical system 200 is described. The charge voltage and the first energy accumulator 201 can be 14.8 V. A maximum output current of the generator 203 can be 250 A.

It is possible to assume that the first energy accumulator 201 is fully charged and has a first maximum open-circuit voltage 101 of 13 V, and that the vehicle electrical system current in the rear region of the vehicle is 40 A, and that typical line resistances are present. The open-circuit voltage of the second energy accumulator 202 is then also approximately 13.0 V. So that in the case of recuperation the current which is generated by the generator 203 can be absorbed completely, under the abovementioned assumptions the second energy accumulator 202 should have an internal resistance of at maximum 8.5 mohms for a charge pulse of 10 seconds duration given a typical test temperature of a consumption cycle (20-30° C.). If a relatively high power generator 203 with 400 A uses a maximum current under otherwise identical peripheral conditions, the permissible internal resistance is reduced to 5 mohms. If the second energy accumulator 202 is located in the rear region (as illustrated in FIG. 6a) and the generator voltage is limited to 15.5 V, the requirement with respect to the internal resistance is tightened to at maximum 7.6 mohms (in the case of an output current of 250 A) or respectively 2.9 mohms (in the case of an output current of 400 A). These relatively stringent requirements of the internal resistance result, in particular, from the additional line resistance between the generator 203 and the second energy accumulator 202. It is therefore advantageous to arrange the second energy accumulator 202 in the direct vicinity of the generator 203.

For the recuperation, a charging range of approximately 3 Ah should be available in order to be able to make maximum use of recuperation phases in typical consumption test cycles of a vehicle 600. This charging range is represented by the reference number 113 in FIG. 1. The charging range should be available here in the buffer voltage range 105 (e.g. in a range from 13.0 V to 14.0 V) in order to avoid a partial discharge of the first energy accumulator 201 and continuously excessively high voltage at the first energy accumulator 201 (which can lead to a significantly increased gassing stream with corresponding damage to the first energy accumulator 201). A medium voltage level of 13.5 V results for the abovementioned buffer voltage range 105, giving rise to increased demands of the internal resistance of the second energy accumulator 202 to at maximum 6.5 mohms (250 A generator) or at maximum 3.6 mohms (400 A generator).

The present document has described a multiplicity of measures for making available a vehicle electrical system 200 which permits a high degree of recuperation in a cost-effective fashion. In particular, vehicle electrical systems 200 have been described in which a second energy accumulator 202 for absorbing recuperated energy is located in the front vehicle region, i.e. in the direct vicinity of a generator 203. On the other hand, a first energy accumulator 201 for making available stationary-mode energy and starting energy can be located in the front or rear vehicle regions. The first and second energy accumulators 201, 202 can be connected directly in parallel, or in particular equipped in conjunction with a starter-generator 403 with a coupling element 401 and connected.

In preferred examples, the first energy accumulator 202 is composed of one or more of the energy accumulator configurations described in this document. A gross capacity of at maximum 25 Ah is typically sufficient for the second energy accumulator 202 for the recuperation function described in this document, with the result that the second energy accumulator 202 can be implemented in a cost-effective fashion. As is presented in this document, the second energy accumulator 202 is used primarily for cyclically absorbing and making available recuperated electrical energy, with the result that the second energy accumulator 202 should have a highest possible P/E ratio of at least 30 in the case of 25° C. (10 seconds discharging with respect to gross energy content). In order to be able to absorb the generated energy as completely as possible in recuperation phases, the second energy accumulator 202 can have a charging range of 3 Ah in the open-circuit voltage range 13.0 V to 14.0 V. Furthermore, the second energy accumulator 202 can have an internal resistance with respect to charging of at maximum 6.5 mohms, given charging for 10 seconds at 25° C., starting at an open-circuit voltage which is at 50% of the energy content in the open-circuit voltage range 13.0 V-14.0 V.

For the apportioning of the functions described in this document, the first energy accumulator 201 can have at least 3 times the capacity of the second energy accumulator 202.

The present invention is not limited to the exemplary embodiments shown. In particular it is to be noted that the description and the figures are intended to illustrate only the principle of the proposed methods, devices and systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle electrical system for a vehicle, wherein the vehicle electrical system comprises:
a first energy accumulator which has a first maximum open circuit voltage when the first energy accumulator is fully charged;
a second energy accumulator which has a second maximum open-circuit voltage when the second energy accumulator is fully charged, wherein the second maximum open circuit voltage is higher than the first maximum open circuit voltage;
a generator configured to generate electrical energy for the vehicle electrical system; and
a control unit configured to:
detect a recuperation mode of the vehicle, and
cause the generator, while the vehicle is in the recuperation mode, to generate electrical energy with a charge voltage which is in or above a buffer voltage range, wherein the buffer voltage range lies between the first maximum open circuit voltage and the second maximum open circuit voltage.

2. The vehicle electrical system as claimed in claim 1, wherein the control unit is configured, while the vehicle is in the recuperation mode, to cause the generator to generate electric energy exclusively with a charge voltage which is in or above a buffer voltage range.

3. The vehicle electrical system as claimed claim 1, wherein at least one of:
the first maximum open circuit voltage is equal to or lower than 13V;
the second maximum open circuit voltage is equal to or higher than 14V; and
the buffer voltage range comprises, if appropriate exclusively voltages between 13V and 14V.

4. The vehicle electrical system as claimed claim 2, wherein at least one of:
the first maximum open circuit voltage is equal to or lower than 13V;
the second maximum open circuit voltage is equal to or higher than 14V; and
the buffer voltage range comprises, if appropriate exclusively voltages between 13V and 14V.

5. The vehicle electrical system as claimed in claim 1, wherein at least one of:
the first energy accumulator is configured to make available electrical stationary mode energy and starting energy for the vehicle; and
the second energy accumulator is configured to store and make available electrical energy in a cyclical fashion, in particular in 3000 or more full cycles given a loss of a capacity of the second energy accumulator of 20% or less and/or given a power loss of 50% or less.

6. The vehicle electrical system as claimed in claim 2, wherein at least one of:
the first energy accumulator is configured to make available electrical stationary mode energy and starting energy for the vehicle; and
the second energy accumulator is configured to store and make available electrical energy in a cyclical fashion, in particular in 3000 or more full cycles given a loss of a capacity of the second energy accumulator of 20% or less and/or given a power loss of 50% or less.

7. The vehicle electrical system as claimed claim 1, wherein the second energy accumulator has a rated capacity which corresponds to a third or less of a rated capacity of the first energy accumulator.

8. The vehicle electrical system as claimed claim 2, wherein the second energy accumulator has a rated capacity which corresponds to a third or less of a rated capacity of the first energy accumulator.

9. The vehicle electrical system as claimed in claim 1, wherein the first energy accumulator comprises a battery cell which is based on lead acid technology.

10. The vehicle electrical system as claimed in claim 1, wherein the second energy accumulator comprises at least one of:
ten cells which are connected in series and are based on nickel metal hydride technology;
a series circuit of four cells which are based on lithium ion technology, with a metal oxide cathode, in particular a nickel manganese cobalt cathode and/or a lithium manganese oxide cathode, and with an anode which is based on carbon;
a series circuit of four cells which are based on lithium-ion technology, with a lithium iron phosphate cathode and with an anode which is based on carbon;
a series circuit of six cells which are based on lithium-ion technology, with a metal oxide cathode, in particular a nickel manganese cobalt cathode and/or a lithium manganese oxide cathode, and with an anode which is based on lithium titanate; and
a series circuit of eight cells which are based on lithium-ion technology, with a lithium iron phosphate cathode and an anode which is based on lithium titanate.

11. The vehicle electrical system as claimed in claim 1, wherein the second energy accumulator has at least one of:
a rated capacity of at most 25 Ah;
a ratio of discharge power to gross energy content of at least 30 at an operating temperature of 25° C. and a state of charge of 50%;
a charging range of 3 Ah or more in the buffer voltage range; and
an internal resistance of 6.5 mohms or less at a state of charge of 50% when the second energy accumulator is at an operating temperature of 25° C. and/or in the buffer voltage range.

12. The vehicle electrical system as claimed in claim 1, wherein in the case of operating temperatures of 0° C. or less, the second energy accumulator has a charge absorption capacity which is higher than a charge absorption capacity of the first energy accumulator.

13. The vehicle electrical system as claimed in claim 1, wherein
the vehicle electrical system comprises an isolating element which is configured to prevent a flow of current between the second energy accumulator and the vehicle electrical system; and
the control unit is further configured to:
determine when one or more isolating conditions are met, and
cause, when one or more isolating conditions are met, the isolating element to prevent the flow of current between the second energy accumulator and the vehicle electrical system,
wherein the one or more isolating conditions comprise at least one of:
a first isolating condition in which the first energy accumulator has a state of charge which is equal to or higher than a predefined first charge threshold value, in which the second energy accumulator has a state of charge which is equal to or higher than a predefined second charge threshold value, and in which the vehicle is in a resting phase,
a second isolating condition in which there is an indication that electrical energy is to be reserved for an emergency start of the vehicle, and
a third isolating condition in which there is an indication that an open circuit voltage measurement is to be carried out at the first energy accumulator and/or at the second energy accumulator.

14. The vehicle electrical system as claimed claim 1, wherein
the vehicle electrical system comprises a bypassable additional resistor which divides the vehicle electrical system into a first part with the first energy accumulator and into a second part with the second energy accumulator; and
the control unit is configured to cause, when a starter is activated, bypassing of the bypassable additional resistor to be cancelled in a coasting mode of the vehicle.

15. The vehicle electrical system as claimed in claim 1, wherein
the generator is arranged in a first region of the vehicle;
the first region comprises either a front region or a rear region of the vehicle; and
the second energy accumulator is arranged in the first region of the vehicle.

16. The vehicle electrical system as claimed in claim 15, wherein the first energy accumulator is one of:
arranged in the first region, and
arranged in the second region which corresponds to a region of the vehicle which is opposite the first region.

17. A vehicle electrical system for a vehicle, wherein the vehicle electrical system comprises:
a first energy accumulator; wherein the first energy accumulator comprises a battery cell which is based on lead acid technology; and
a second energy accumulator; wherein the second energy accumulator comprises at least one of:
ten cells which are connected in series and are based on nickel metal hydride technology;
a series circuit of four cells which are based on lithium ion technology, with a metal oxide cathode, in particular a nickel manganese cobalt cathode and/or a lithium manganese oxide cathode, and with an anode which is based on carbon;
a series circuit of four cells which are based on lithium-ion technology, with a lithium iron phosphate cathode and with an anode which is based on carbon;
a series circuit of six cells which are based on lithium-ion technology, with a metal oxide cathode, in particular a nickel manganese cobalt cathode and/or a lithium manganese oxide cathode, and with an anode which is based on lithium titanate; and
a series circuit of eight cells which is based on lithium-ion technology, with a lithium iron phosphate cathode and an anode which is based on lithium titanate.

18. A vehicle electrical system for a vehicle, wherein the vehicle electrical system comprises:
a first energy accumulator; and
a second energy accumulator;
wherein at least one of:
the second energy accumulator has a rated capacity which corresponds to a third or less of a rated capacity of the first energy accumulator,
the second energy accumulator has, in the case of operating temperatures of 0° C. or less, a charge absorption capacity which is higher than a charge absorption capacity of the first energy accumulator,
the second energy accumulator has a rated capacity of a maximum of 25 Ah,
the second energy accumulator has a ratio of the discharge power to the gross energy content of at least 30, in particular in the case of an operating temperature of 25° C. and in the case of a state of charge of 50%,
the second energy accumulator has a charging range of 3 Ah or more for a recuperation mode of the vehicle, and
an internal resistance of 6.5 mohms or less, in particular in the case of a state of charge of 50%, and in the case of an operating temperature of 25° C.

19. A vehicle electrical system for a vehicle, wherein the vehicle electrical system comprises:
a first energy accumulator;
a second energy accumulator; and
a generator which is configured to generate electrical energy for the vehicle electrical system,
wherein the generator is arranged in a first region of the vehicle,
wherein the first region comprises either a front region or a rear region of the vehicle, and
wherein the second energy accumulator is arranged in the first region of the vehicle.
